(19) United States
(12) Patent Application Publication
(10) Pub. No.: US 2009/0220316 A1
(43) Pub. Date: Sep. 3, 2009

(54) SPREADING PLUG

(76) Inventors: Klaus Burger, Überlingen-Nussdorf (DE); Dieter Schmid, Stockach (DE); Bernd Karotsch, Bodman-Ludwigshafen (DE); Uwe Johnen, Singen (DE)

Correspondence Address: OSTROLENK FABER GERB & SOFFEN, 1180 AVENUE OF THE AMERICAS, NEW YORK, NY, 100368403, US

(21) Appl. No.: 12/278,207

(22) PCT Filed: Feb. 2, 2007
(86) PCT No.: PCT/EP2007/000917

§ 371 Date: Feb. 20, 2009

(30) Foreign Application Priority Data
Feb. 4, 2006 (DE) 10 2006 005 091.6

(51) Int. Cl. F16B 13/06

(52) U.S. Cl. 411/39

(57) ABSTRACT

The object of the invention is a spreading plug which preferably comprises plastic and has a plurality of slots in the plug cover, between which slots spreading segments are formed which are spread outward against the wall of the drilled hole when a screw or another spreading element is screwed into the central insertion channel of the plug. In order to obtain a plurality of spreading regions which are distributed over the axial plug length, for the purpose of a more uniform spreading action, a plurality of slot arrangements are provided which are arranged offset with respect to one another both in the circumferential direction and in the axial direction. Preferably, a first slot which extends over the diameter of the plug is provided over a part length of the shaft and a further continuous slot is provided, offset in the circumferential direction by 90°, over the remaining part of the plug length as far as the plug base. Here, the two slot pairs overlap one another in the central region. Moreover, preferably window slots which lie opposite one another are provided in the plug base region, in which window slots rotary vanes can move which are integrally formed on the plug sleeve by way of their plug-base-side end via a joint, spread outwards when the screw is screwed in and ensure both rotational securing and securing against being pulled out axially.

The invention relates to a spreading plug with a plug jacket having a plug neck, a plug shank, a plug foot and a continuous spreading means insertion hole.

Spreading plugs of this type are known in a broad range of embodiments. Conventionally, the plug jacket is provided in this case with three longitudinal slots which are arranged at the same angular distance and form three spreading elements which spread outward against the wall of the drilled hole when a screw is screwed in. Reliable securing of the plug can be achieved in this way in cleanly drilled cylindrical drilled holes, for example in concrete. In porous brickwork or in hollow blocks or excessively large drilled holes, the extraction resistance is frequently insufficient. In order to be able to achieve support in hollow blocks, spreading plugs are also known which are configured as buckling plugs and in which the screw in the plug foot incises a thread and the plug is axially compressed, as a result of which the jacket segments, which encounter no resistance in the drilled hole, are tied together behind the wall of the hole.

DE 75 10 134 U discloses a spreading plug having a cylindrical plug jacket, the plug foot of which has a bevel, and from the rearward end of which a forwardly tapered cavity emanates. The plug jacket has two transverse slots, of which the first emanates from the plug neck and the second is offset rearwardly thereto by 90°. The second transverse slot is closed at the rearward plug end in the region of the plug foot by short projections formed integrally with the circumference. The first transverse slot extends up to at most ⅔ of the length of the plug from the leading plug end. The rearward transverse slot, which is offset by 90° thereto, also extends up to ⅔ of the length of the plug. The receiving bore for a spreading element opens at the rearward end of the plug, the bore tapering forward and overall reaching forward up to two thirds of the total length of the plug. The plug described therein is made of deformable material, preferably of flexible plastics material. Owing to the continuously cylindrical shape of the plug jacket, said plug jacket has difficulty when spreading out adapting to non-uniformities in the shape of the drilled hole along the length thereof, such as inevitably occur for example in hollow perforated bricks.

DE 93 12 057 U1 discloses a plastics material plug, preferably for hollow perforated bricks, having a longitudinal bore and at least two spreading parts which are arranged in succession and each separated from one another by transverse slots. The first spreading part is delimited by a sleeve-like head and shank part. The second spreading part is delimited by the shank and foot part. The head and shank part has a longitudinal bore corresponding to the outer diameter of the fastening screw. The longitudinal bore in the foot part is provided with an inner thread adapted to the thread of the fastening screw. The two spreading parts are offset from each other by 90°. In this way, the spread-out legs lie one above the other in the shape of a cross. During tightening of the fastening screw, the legs, which are located in cavities of the hollow perforated brick, of both spreading parts are buckled radially outward and form a thickening in these cavities. For this purpose, it is necessary for the cavities in the direction of the plug bore to have dimensions corresponding approximately to the length of the transverse slots.

DE 198 49 821 A1 discloses a plastics material spreading plug with a spreading part which can be secured by screwing in a fastening screw. The plug is provided with a longitudinal bore which is formed on the plug neck by a cylindrical portion which tapers conically toward the plug foot in a plurality of stages. The plug has a first spreading part which directly adjoins the cylindrical part of the bore and is formed by a longitudinal slot which divides the spreading part into two legs. This spreading part is adjoined by a second spreading part. The longitudinal slot of the second spreading part is offset by 90° relative to the longitudinal slot of the first spreading part. The longitudinal slots of the two spreading parts can overlap. Both spreading parts have on their outer surface saw tooth-shaped notches. This produces an outer surface which has good grip and allows the teeth formed by the notches to penetrate the wall of the drilled hole.

The invention is based on the object of providing a spreading plug which is universally suitable for a broad range of application purposes, has improved holding values and adapts to the building material as gently as possible.

The object set is achieved by the features specified in claim 1. The arrangement of the slots offset in the circumferential direction and in the axial direction produces different main spreading directions over the length of the plug jacket, as a result of which outstanding securing is achieved even in drilled holes which extend disadvantageously. Whereas in the previously known spreading plugs the spreading effect was limited to a relatively large axial region of the length of the plug, the invention forms two or more axially spaced-apart or overlapping regions which have different main spreading directions and are for their part divided by annular grooves into individual, axially successive spreading portions, allowing more precise and flexible adaptation to the drilled hole. A plurality of regions of this type can be arranged over the length of the plug, although it is generally expedient and sufficient to provide two such regions each having slots extending over the diameter, thus forming two main spreading directions which are positioned at an angle of 90° relative to each other. Such a paired arrangement of slots means that, during spreading, the plug sleeve is spread in four directions uniformly but offset in depth. The pairs of slots thus formed are expediently arranged so as to overlap, i.e. the slots of one pair engage with that region of the jacket that is penetrated by the other pair of slots. This overlapping of the slots, roughly in the center of the shank, produces at this location also parallel spreading which ensures that the plug sleeve issues the spreading force to the securing base absolutely uniformly in this region. This arrangement is also particularly advantageous when the securing base has become cracked when screwing in the screw. Cracks produced in this way then always run toward the drilled hole.

In order to prevent co-rotation of the plug, which is merely inserted loosely into a drilled hole, when the spreading screw is screwed in, it is known to provide longitudinal ribs which are arranged fixedly on the outer jacket and dig into the wall of the drilled hole; this is disadvantageous especially when the material surrounding the drilled hole is relatively soft.

According to a preferred configuration of the plug, provision is therefore made for the plug jacket to have window slots in which rotary vanes, which at their plug foot-side end are formed integrally with the plug jacket via rotary joints, are radially movably arranged. This provides particularly beneficial securing of the plug in the drilled hole, because the rotary vanes are displaced inward on insertion of the plug into the drilled hole and are driven outward only on insertion of the spreading element and then ensure the anti-rotation function.

The formation according to the invention of the plug ensures, even in a relatively long configuration, that the spreading member is guided axially in the insertion hole without drifting laterally.

Further advantageous configurations of the invention emerge from the sub-claims.

Exemplary embodiments of the invention will be described hereinafter with reference to the drawings, in which:

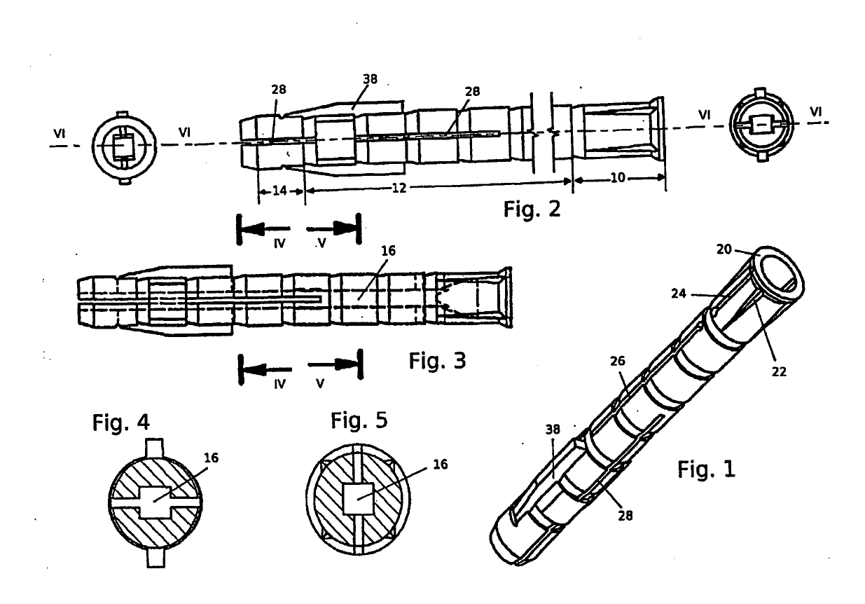

FIG. 1 is a perspective view of a spreading plug according to the invention;

FIG. 2 is a side view of the spreading plug according to FIG. 1, together with axial views onto the plug neck and plug foot;

FIG. 3 is a side view corresponding to FIG. 2 with the insertion hole indicated by broken lines;

FIG. 4 is a section on a larger scale along the line IV-IV according to FIG. 3;

FIG. 5 is a section on a larger scale along the line V-V according to FIG. 3;

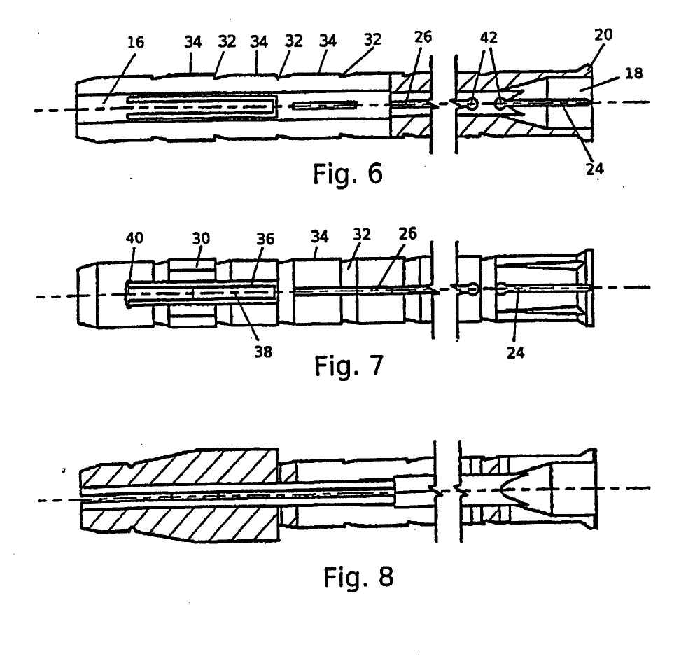

FIG. 6 is a longitudinal section of the spreading plug, cut along the line VI-VI according to FIG. 2;

FIG. 7 is a view, rotated about the plug axis through 90° relative to FIG. 2, of the spreading plug;

FIG. 8 is a vertical section of the plug according to FIG. 7;

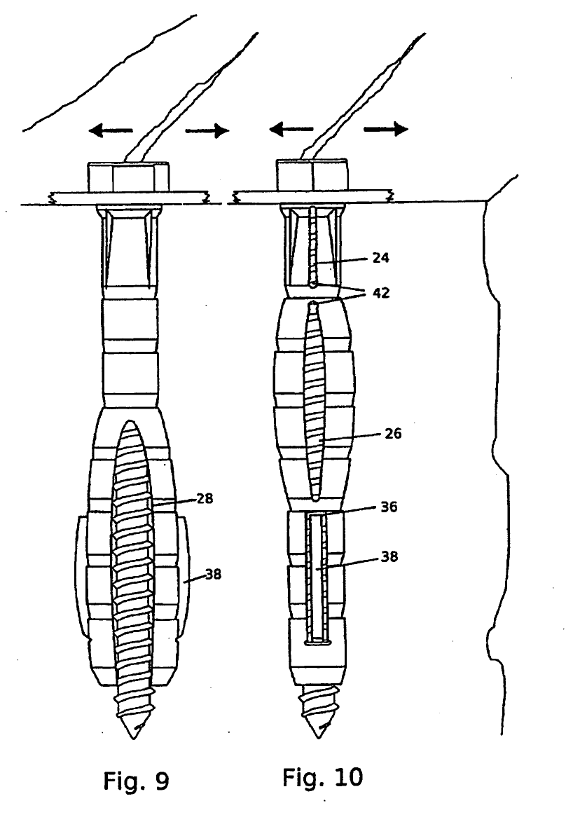

FIG. 9 is a view of the plug with the screw screwed in in the spread-out state;

FIG. 10 shows the plug according to FIG. 9 rotated about the plug axis through 90°; and

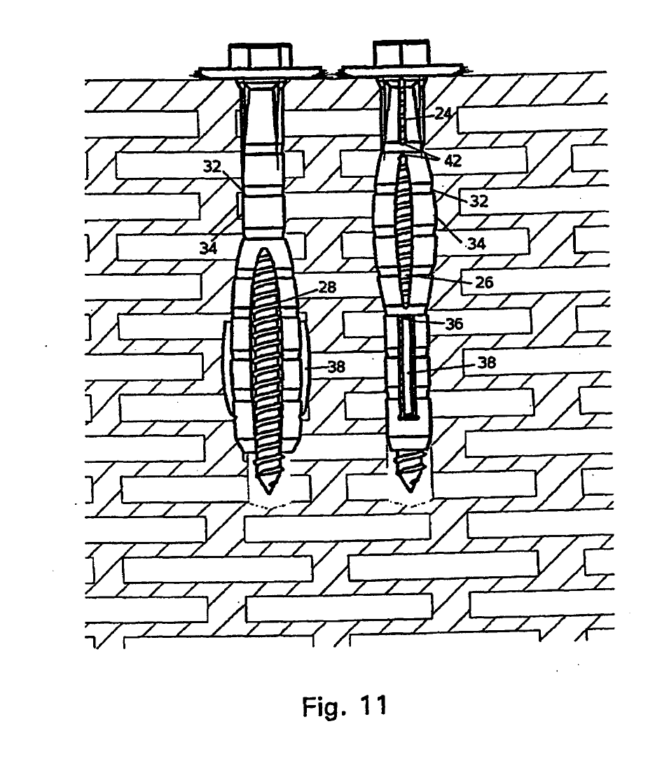

FIG. 11 shows the plug according to FIGS. 9 and 10 in a lightweight vertically perforated brick.

The spreading plug according to the invention, which is preferably made of plastics material, has a plug neck 10, a plug shank 12 and a plug foot 14. An insertion hole 16, which has over the shank region and the plug foot a uniform, in the exemplary embodiment square, cross section and merges in the plug neck with an extension 18 forming a spreading pressure-free zone, extends over the entire length of the plug. The plug neck has a closed setting depth stop 20 and a plurality of axial ribs which are arranged at the same angular distance on the outside as a rotary lock, the height of which decreases after the shank. In order to prevent the ribs from becoming torn off and their anti-rotation effect from becoming lost when the plug neck is driven into the drilled hole, an axial slot 24, which extends over the diameter, ends in the setting depth stop and causes crushing of the plug neck on insertion, so that the function of the rotary lock is maintained, is provided in the plug neck.

The plug shank 12 has two first longitudinal slots 26 which are offset by 180°, start at a distance from the slots 24 and end in the shank 12. Offset by 90° from these first longitudinal slots 26, the plug jacket has in the shank 12 two further diametrically opposing second longitudinal slots 28 which pass through the plug foot 14 and divide said plug foot into two spreading segments. This achieves a spreading function over the entire length of the plug. The second slots 28 are bridged in the region of transition between the shank and foot by bridging elements 30 which prevent premature spreading. According to the illustrated exemplary embodiment, the longitudinal slots 26 and 28 overlap by a certain distance in the end portion of the shank that faces the plug foot.

In the shank portion and in the plug foot portion, the plug jacket is provided with annular grooves 32 of triangular cross section, thus forming annular spreading portions 34 distributing the spreading energy.

In this way, the plug is particularly suitable for use in lightweight vertically perforated bricks, such as is shown in FIG. 11, as the inner webs of these bricks are relatively thin compared to inner wall bricks. Lightweight vertically perforated bricks are used as heat insulation bricks in outer walls and are distinguished by a low bulk density and a particular hole pattern. The inner webs of these bricks have a wall thickness of from 3 to 6 mm. The hollow chambers are relatively small; the height of the chambers is from 5 to 15 mm longitudinally to the plug axis. The bulk density of bricks of this type is less than 1.0 kg/dm³.

The distribution of the spreading energy onto the spreading portions 34 acts particularly gently on these inner webs. The continuous adaptation of the spreading portions 34 of the plug to the building material is also apparent from FIG. 11. The plug sleeve rests against a large number of individual inner webs. The load bearing performance corresponds roughly to a resiliently embedded beam. The individual spreading portions 34 adapt to the brick. If a spreading portion is located in a cavity, the annular grooves 32 additionally behave like barbs. Via the large number of inner webs, the plug also resists extraction via frictional engagement.

In the direction of the first longitudinal slots 26, window slots 36, which are widened with spacing and extend into the plug foot, adjoin on the side of the plug foot. Rotary vanes 38 in the plug foot 14 are formed integrally with the plug foot-side end of these window slots via rotary joints 40. These rotary vanes are able to move freely in the window slots 36 and form, spread outward, a rotary vane lock.

The surface of the plug jacket offers maximum frictional area as resistance to extraction. At the same time, the profiles allow the plug jacket to adapt optimally to unevenness as a result of the spreading segments which are able to move relative to one another.

In order to avoid at the ends of the slots notch effects in the plastics material, roundings 42 were provided at the prominent slot ends, allowing tension peaks owing to the spreading and deformation effects to be broken down.

The rotary vanes 38, which are arranged on the plug foot so as to be able to pivot laterally, can, on introduction of the plug into the drilled hole, fold inward into the insertion hole 16 through the window slots 36. When the spreading element is screwed into the insertion hole, the rotary vanes are pressed outward against the wall of the drilled hole and prevent co-rotation of the plug. The rotary vane locks can reach with their barb-like ends through existing drilled hole projections and thus generate additional support even in hollow blocks. This leads to optimum adaptation to the building material. The insertion hole 16 forming the spreading channel is optimized in such a way as to allow a broad range of spreading elements, such as clamping plate screws and wood screws, to be screwed in in such a way as to produce a beneficial spreading effect. At the same time, the torque required for screwing in the screw does not rise in such a way as to cause excessive torsional stressing of the screw. Instead of screws, the spreading elements can also be secured in the drilled hole while being spread out by striking elements such as nails.

The arrangement, offset in the circumference, of the overlapping spreading slots 26 and 28 causes, as may be seen from FIGS. 9 and 10, spreading-out in a plurality of circumferentially offset directions. The spreading parts, which are offset from one another by 90°, are stressed, when the spreading element is screwed in, in two main spreading directions which are offset from each other by 90°. The elements are arranged in such a way that the energy which occurs and provides the resistance to extraction of the plug sleeve distributes the effect of the force around the plug, i.e. the spreading force is transmitted into the securing base uniformly in all directions in a gentle manner. Two axially overlapping pairs of spreading slots 26, 28, which are offset in the circumferential direction by in each case 90°, are provided in the illustrated exemplary embodiment. However, it should also be reserved for the invention to arrange groups of offset slots consisting of three or more slots, for example in each case three first slots, at an angular distance of 120° and to offset them at an angle of 60° relative to second individual slots. According to the exemplary embodiment, the slots extend in the axial direction. For the invention, it should however be reserved to arrange the slots so as to extend obliquely or helically in a corresponding offset arrangement; this can result in further optimization during screwing-in and spreading.

According to the exemplary embodiment, the rotary vanes are arranged in the plug foot in an articulated manner. It is however also conceivable to place said rotary vanes further into the shank region. The important thing in this case is that these rotary vanes can swivel within their windows inwardly into the insertion channel in order then to be pressed outward against the wall of the drilled hole when the screw is screwed in.

Thus, within the scope of the present invention, still further alterations, modifications or design changes can be brought about without departing from the scope of the invention.

1. A spreading plug, preferably made of plastics material, with a plug neck (10), a plug shank (12), a plug foot (14) and a continuous spreading means insertion hole (16), characterized in that first slots (26), which are offset in the circumferential direction and form spreading segments which can be spread against the wall of the drilled hole on insertion of a spreading element, are arranged at least in the region of the shank (12), second slots (28), which are offset in the circumferential direction from one another and from the first slots (26) and axially relative to the first slots (26), being provided in the plug jacket, the first and second slots (26, 28) being arranged so as to overlap each other in the longitudinal direction, and at least the shank region being divided by annular grooves (32) into the individual, axially successive spreading portions (34).

2. The spreading plug as claimed in claim 1, characterized in that the first and/or the second slots (26, 28) are arranged in pairs offset from one another by 90°.

3. The spreading plug as claimed in claim 1 or 2, characterized in that all slots (26, 28) extend parallel to the axis.

4. The spreading plug as claimed in claim 1 or 2, characterized in that the first and/or the second slots (26, 28) extend obliquely, for example helically, to the longitudinal axis.

5. The spreading plug as claimed in one of the preceding claims, characterized in that the plug jacket has window slots (36) in which rotary vanes (38), which at their plug foot-side end are formed integrally with the plug jacket via rotary joints (40), are radially movably arranged.

6. The spreading plug as claimed in claim 5, characterized in that the rotary vanes (38) are folded into the window slots (36) on insertion into the drilled hole to prevent them from becoming torn off.

7. The spreading plug as claimed in claim 5 or 6, characterized in that the window slots (36) with the rotary vanes (38) are arranged in the plug foot region at the same angular distance from one another.

8. The spreading plug as claimed in one of the preceding claims, characterized in that the insertion channel (16) has in the plug neck on extension (18) to form a spreading pressure-free region.

9. The spreading plug as claimed in one of claims 1 to 8, characterized in that the slot ends have roundings (42) to avoid a notch effect.

10. The spreading plug as claimed in one of claims 1 to 9, characterized in that anti-rotation ribs (22) and at least one axial slot (24) are provided in the neck region.

11. The spreading plug as claimed in claim 10, characterized in that the axial slots (24) in the neck part end in a continuous setting depth stop (20).

12. The spreading plug as claimed in one of claims 1 to 11, characterized in that at least one of the slots is spanned by bridging elements (30).
